(19) United States
(12) Patent Application Publication
(10) Pub. No.: US 2026/0207413 A1
(43) Pub. Date: Jul. 23, 2026

(54) FOLDABLE WALKER

(71) Applicant: JIANGYIN HUASHI MEDICAL EQUIPMENT CO., LTD., Jiangyin (CN)

(72) Inventor: Pinghua SHI, Jiangyin (CN)

(73) Assignee: JIANGYIN HUASHI MEDICAL EQUIPMENT CO., LTD., Jiangyin (CN)

(21) Appl. No.: 19/026,778

(22) Filed: Jan. 17, 2025

(51) Int. Cl. A61H 3/04

(52) U.S. Cl. CPC A61H 3/04; A61H 2003/043; A61H 2201/0161; A61H 2201/0192; A61H 2201/1253; A61H 2201/1671; A61H 2201/1676

(57) ABSTRACT

A foldable walker includes two walker frames arranged in parallel and a connection mechanism connected with the two walker frames. Each of the two walker frames includes a folding assembly, a handle disposed above the folding assembly, a front leg disposed at the front of a lower part of the folding assembly and a rear leg disposed at the back of the lower part of the folding assembly, and the front leg and the rear leg are turned over and folded toward the handle around the folding assembly; the front leg is provided with a front wheel and the rear leg is provided with a rear wheel. With the connection mechanism and the folding assembly, the folding of the walker frames and the legs of the walker frames can be carried out, and reliable and stable locking can be realized in the folded and unfolded states.

### TECHNICAL FIELD

The present disclosure relates to the field of rehabilitation assistance appliances and in particular to a foldable walker.

### BACKGROUND

The walkers are walking assistance tools specially designed for the elderly with mobility issues or the rehabilitees. The existing walkers are mostly of integral structure. After they are used, the walkers usually take up large space, leading to inconvenience of storage and carriage.

### SUMMARY

In order to overcome the problems of poor portability, large occupation space and inconvenience of storage of the existing walkers, the present disclosure provides the following solution.

The present disclosure provides the following technical solution: there is provided a foldable walker, which includes two walker frames arranged in parallel and a connection mechanism connected with the two walker frames; each of the two walker frames includes a folding assembly, a handle disposed above the folding assembly, a front leg disposed at the front of a lower part of the folding assembly and a rear leg disposed at the back of the lower part of the folding assembly; and the front leg and the rear leg are turned over and folded toward the handle around the folding assembly; the front leg is provided with a front wheel and the rear leg is provided with a rear wheel.

Furthermore, the folding assembly includes a folding frame body, a hand wheel mounted in the middle of the folding frame body, and a front locking pin and a rear locking pin slidably mounted in the folding frame body; the front leg has a front hinging shaft which is rotatably mounted at the front of a lower part of the folding frame body; at least one front fitting groove is disposed on the front hinging shaft and the front locking pin is slidably inserted into the front fitting groove; a front leg spring pulling the front locking pin toward the front hinging shaft is disposed on the folding frame body; the rear leg has a rear hinging shaft which is rotatably mounted at the back of the lower part of the folding frame body; the rear hinging shaft is provided with at least one rear fitting groove, and the rear locking pin is slidably inserted into the rear fitting groove; a rear leg spring pulling the rear locking pin toward to the rear hinging shaft is disposed on the folding frame body; the hand wheel is rotated to adjust insertion depths of the front locking pin into the front fitting groove and the rear locking pin into the rear fitting groove.

Furthermore, a rotary shaft is disposed on the hand wheel, and a blocking tongue is convexly disposed on the rotary shaft radially; a front blocking boss is convexly disposed on the front locking pin radially, and the blocking tongue is attached to a side of the front blocking boss close to the front hinging shaft; a rear blocking boss is convexly disposed on the rear locking pin radially, and the blocking tongue is attached to a side of the rear blocking boss close to the rear hinging shaft.

Furthermore, a front support wall is disposed at the front of the lower part of the folding frame body, a rear support wall is disposed at the back of the lower part of the folding frame body, and a support wheel is disposed in the middle of the lower part of the folding frame body; a support hole is opened on the front support wall and the rear support wall respectively; the front locking pin slides on the support wheel to penetrate through the support hole of the front support wall and then into the front fitting groove; one end of the front leg spring is mounted on the front support wall and the other end is mounted on the front locking pin; the rear locking pin slides on the support wheel to penetrate through the support hole of the rear support wall and then into the rear fitting groove; one end of the rear leg spring is mounted on the rear support wall and the other end is mounted on the rear locking pin.

Furthermore, the connection mechanism includes two support rods and a connection rod hinged on an upper part of each support rod; the two support rods are crossed each other in middle part and hinged to each other, and bottom ends of the two support rods are respectively hinged to the lower parts of the folding frame bodies of the two walker frames; the connection rod on each support rod is hinged close to an upper part of the folding frame body of the walker frame; a catch is further disposed on each support rod, and a locking shaft is disposed on the connection rod hinged to the support rod; the catch is movably snap-fitted to the locking shaft.

The present disclosure has the following beneficial effects: in the foldable walker of the present disclosure, with the connection mechanism and the folding assembly, the folding of the walker frames and the legs of the walker frames can be carried out, and reliable and stable locking can be realized in the folded and unfolded states. In the unfolded state, the entire structure is stable and has strong supporting effect. Further, the folding and unfolding operations are convenient to carry out. The folded structure has the advantages of compact structure and small space occupation.

### BRIEF DESCRIPTION OF THE DRAWINGS

The present disclosure is further described below with the drawings and specific embodiments.

FIG. 1 is a front view illustrating a structure of a walker in an unfolded state in use according to the present disclosure.

FIG. 2 is a right view illustrating a structure of a walker in an unfolded state in use.

FIG. 3 is a structural schematic diagram illustrating a walker in a folded state for storage.

FIGS. 4, 6 and 8 are stereoscopic diagrams illustrating a walker in an unfolded state in use from different view angles.

FIG. 5 is a partially-enlarged view of the position C in FIG. 4.

FIG. 7 is a partially-enlarged view of the position A in FIG. 6.

FIG. 9 is a partially-enlarged view of the position B in FIG. 8.

The numerals of the drawings are described below:

1. walker frame, 2. connection mechanism, 3. folding assembly, 4. handle, 5. front leg, 6. rear leg, 7. front wheel, 8. rear wheel, 9. folding frame body, 10. hand wheel, 11. front locking pin, 12. rear locking pin, 13. front hinging shaft, 14. front fitting groove, 15. front leg spring, 16. rear hinging shaft, 17. rear fitting groove, 18. rear leg spring, 19. rotary shaft, 20. blocking tongue, 21. front blocking boss, 22. rear blocking boss, 23. front support wall, 24. rear support wall, 25. support wheel, 26. support rod, 27. connection rod, 28. catch, and 29. locking shaft.

### DETAILED DESCRIPTION OF THE EMBODIMENTS

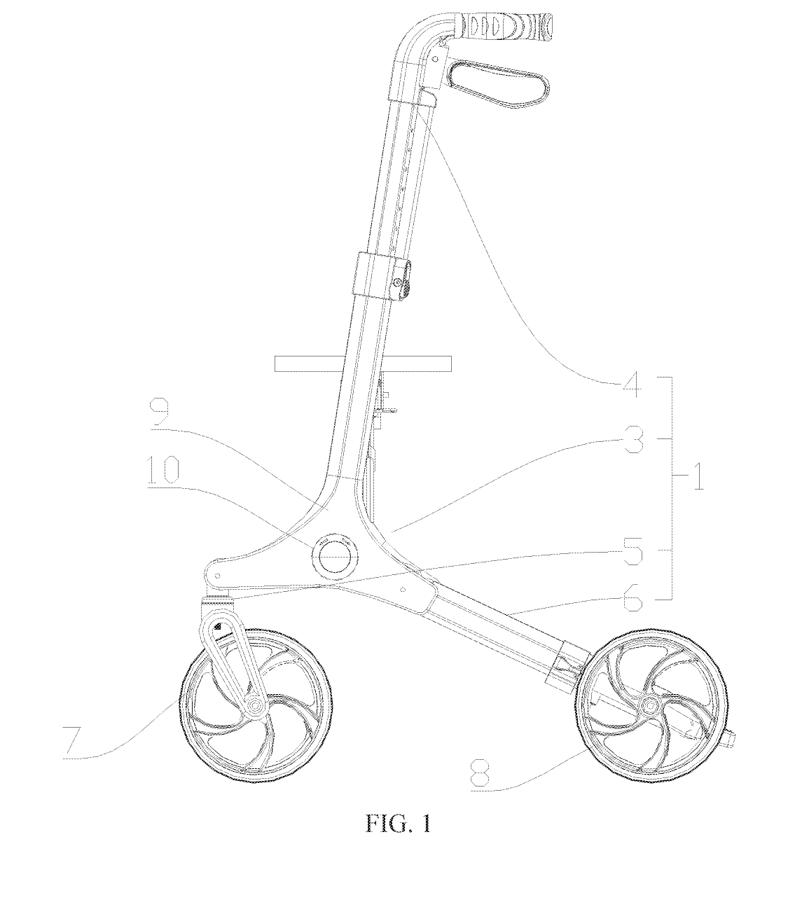

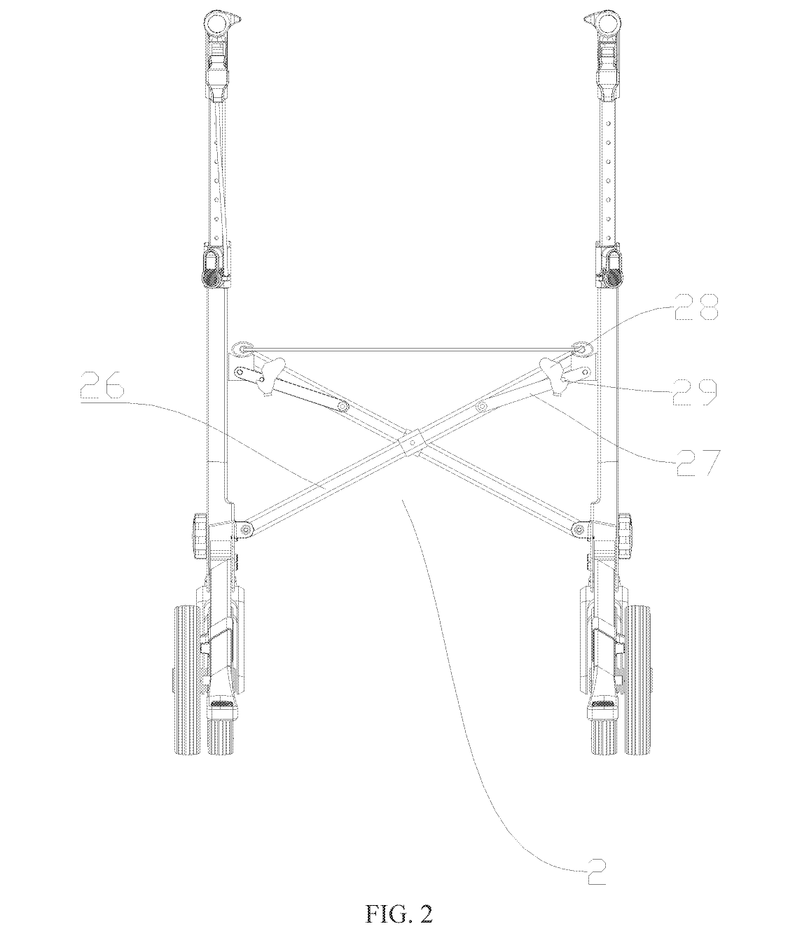

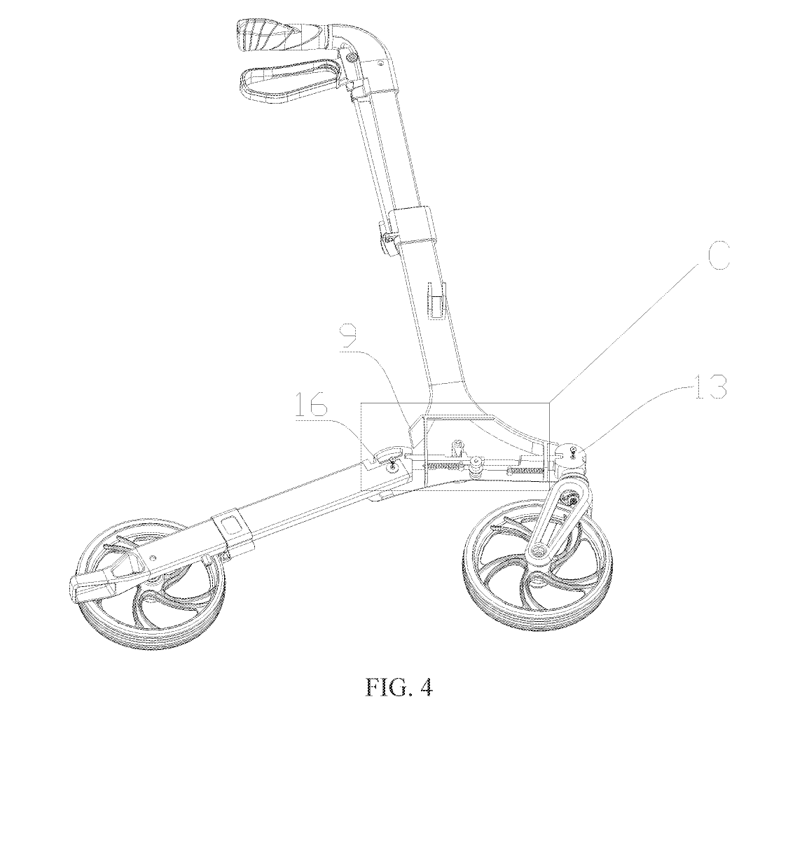

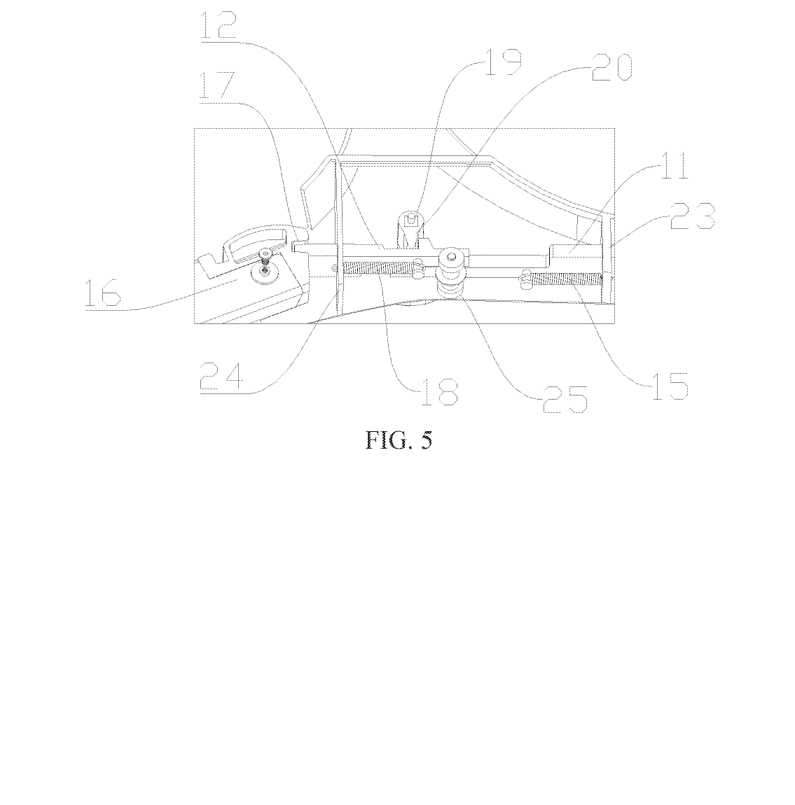

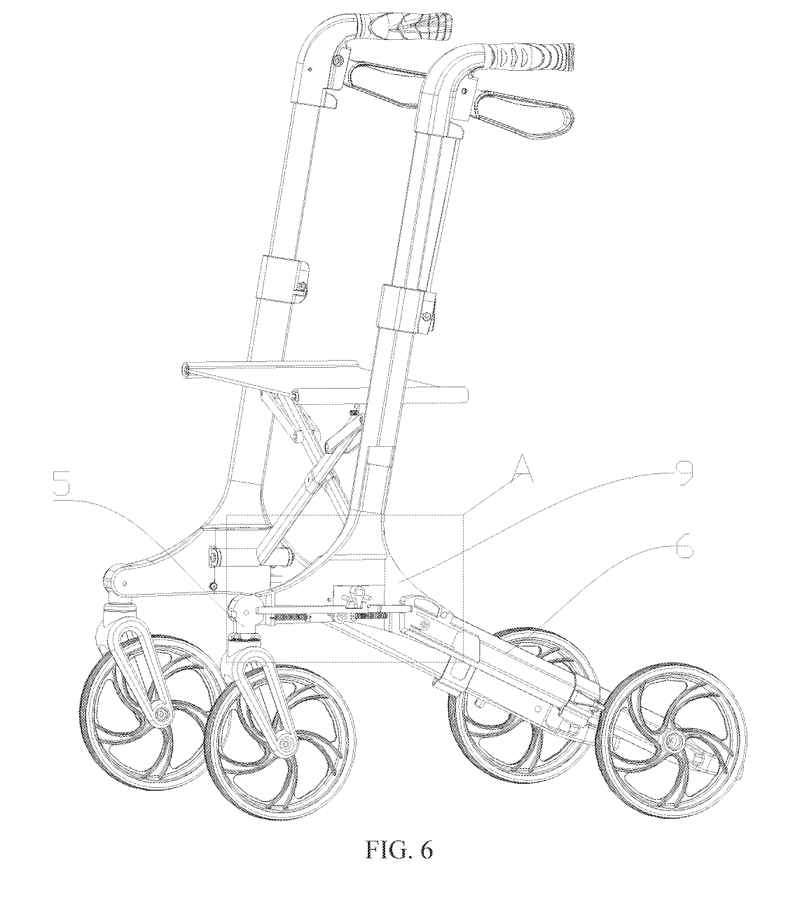

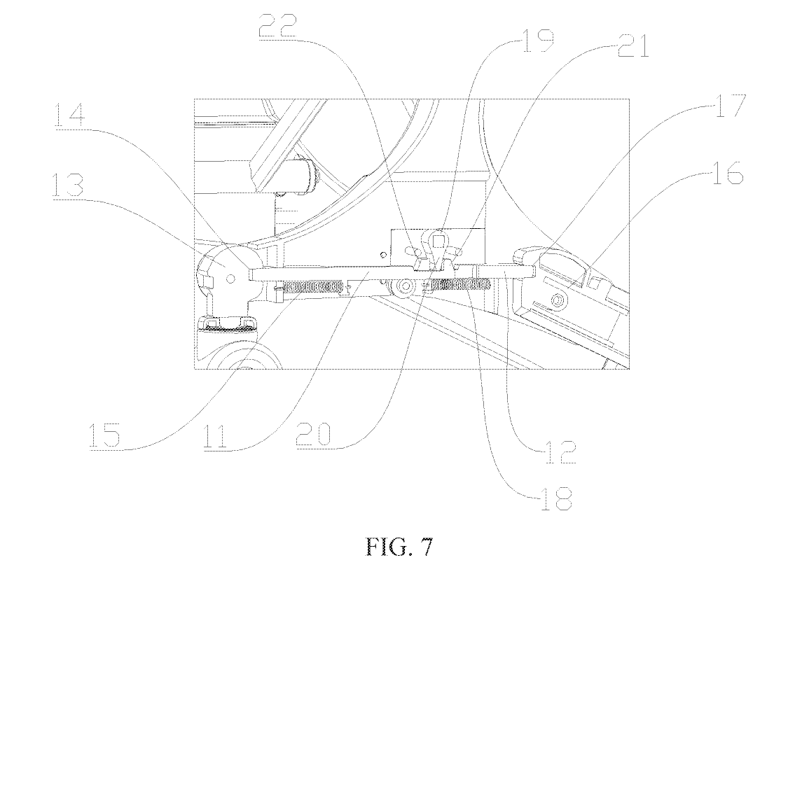

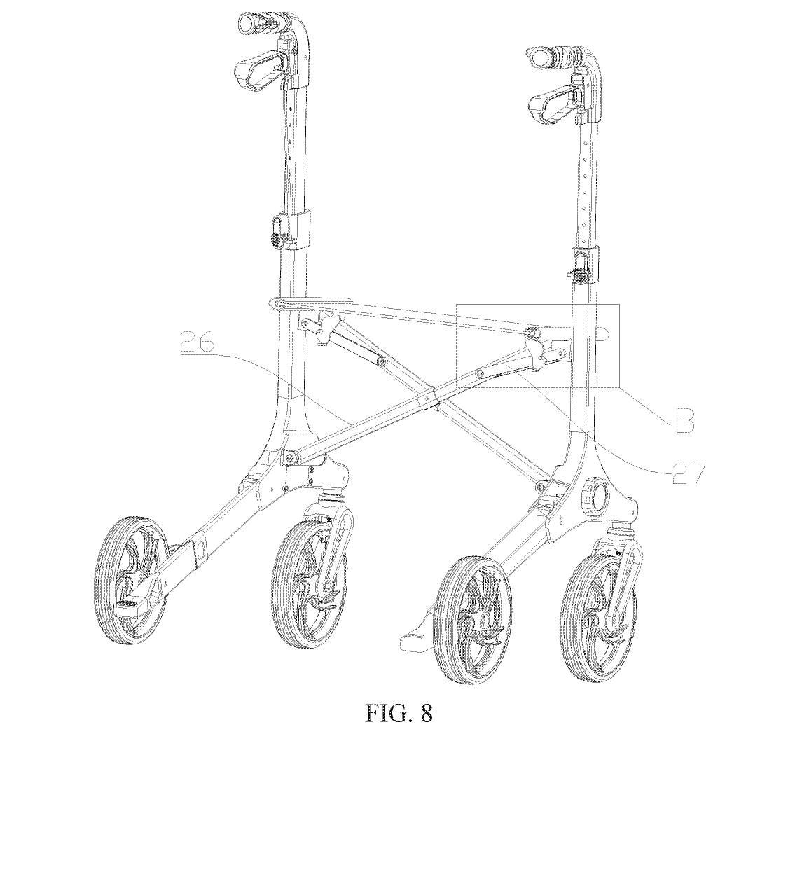

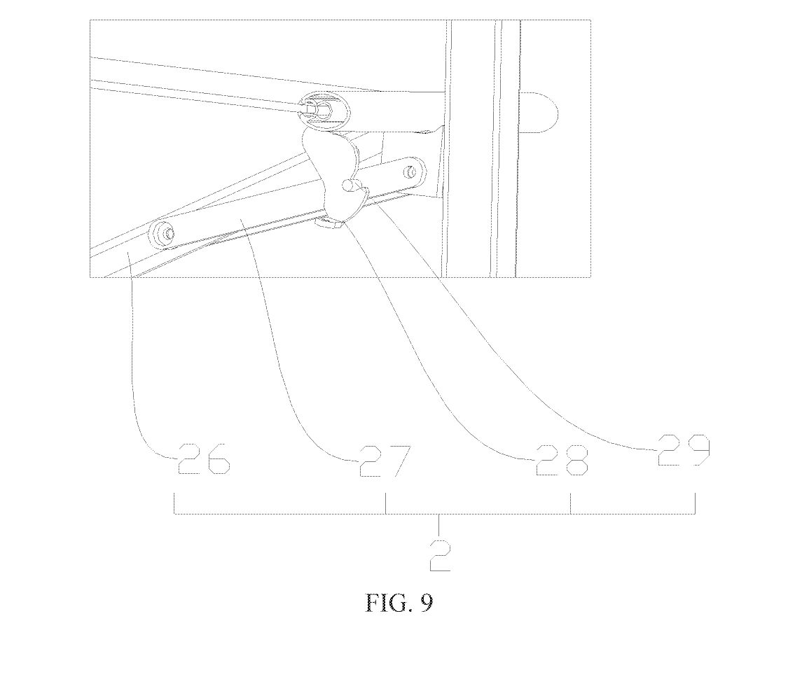

As shown in FIGS. 1 to 9, the present disclosure provides a foldable walker, which includes two walker frames arranged in parallel and a connection mechanism 2 connecting the two walker frames 1. Each of the walker frames 1 includes a folding assembly 3, a handle 4 disposed above the folding assembly 3, a front leg 5 disposed at the front of a lower part of the folding assembly 3 and a rear leg 6 disposed at the back of the lower part of the folding assembly 3. The front leg 5 and the rear leg 6 can be turned over and folded toward the handle 4. The front leg 5 is provided with a front wheel 7 and the rear leg 6 is provided with a rear wheel 8.

The connection mechanism 2 can switch between an unfolded state and a folded state. When the walker is to be used, the connection mechanism 2 is unfolded to support the two walker frames 1. A rigid entirety is formed between the walker frames 1 and the connection mechanism 2 and a user can use the walker to assist walking.

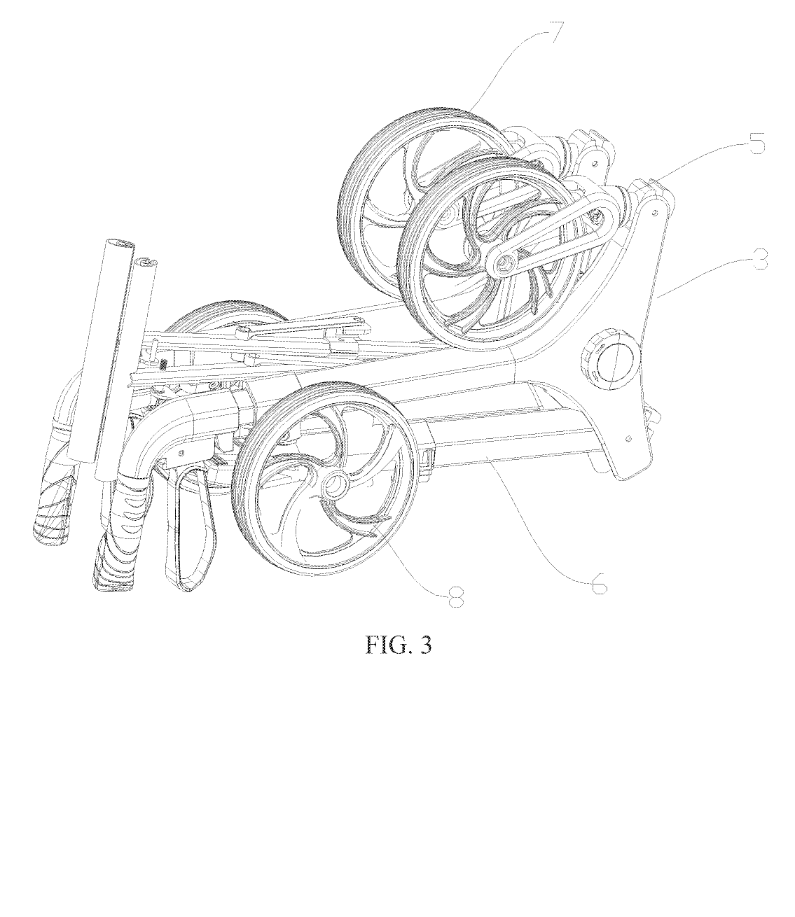

When the walker is to be stored after use, the connection mechanism 2 can be folded to shorten a distance between the two walker frames 1 and reduce a width of the walker. Furthermore, the front leg 5 and the rear leg 6 on the folding assembly 3 are respectively turned over and folded toward the handle 4, such that the front wheel 7, the front leg 6, the rear wheel 8, the rear leg 6 all can be folded around the folding assembly 3. With the folding manner, the finally-formed folding structure is structurally compact, and occupies smaller space, thereby helping the storage of the walker. With reference to FIG. 3, it shows a state of the walker in a completely-folded state.

The folding assembly 3 includes a folding frame body 9, a hand wheel mounted in the middle of the folding frame body 9, and a front locking pin 11 and a rear locking pin 12 slidably mounted in the folding frame body 9. The front leg 5 has a front hinging shaft 13 which is rotatably mounted at the front of a lower part of the folding frame body 9. At least one front fitting groove 14 is disposed on the front hinging shaft 13. The front locking pin 11 is slidably inserted into the front fitting groove 14. A front leg spring 15 pulling the front locking pin 11 toward the front hinging shaft 13 is disposed on the folding frame body 9. The rear leg 6 has a rear hinging shaft 16 which is rotatably mounted at the back of the lower part of the folding frame body 9. The rear hinging shaft 16 is provided with at least one rear fitting groove 17. The rear locking pin 12 is slidably inserted into the rear fitting groove 17. A rear leg spring 18 pulling the rear locking pin 12 toward to the rear hinging shaft 16 is disposed on the folding frame body 9. The hand wheel 10 can be rotated to adjust insertion depths of the front locking pin 11 into the front fitting groove 14 and the rear locking pin 12 into the rear fitting groove 17.

The folding assembly 3 is used to switch the front leg 5 and the rear leg 6 between a folded state and an unfolded state, and lock the front leg 5 and the rear leg 6 in the folded state or unfolded state. Specifically, taking the working process of the front leg 5 as example, descriptions are made below: the front locking pin 11 slides on the folding frame body 9, and the front locking pin 11 is in a state of being tightly pulled outwardly under the traction of the front leg spring 15; the front hinging shaft 13 on the front leg 5 is rotated on the folding frame body 9; when it rotated to an unfolded position, the front fitting groove 14 is aligned with the position of the front locking pin 11. Thus, the front locking pin 11 is slid into the front fitting groove 14, preventing the rotation of the front hinging shaft 13, and limiting the freedom of rotation of the front hinging shaft 13. In this way, the front leg 5 is locked in the unfolded state. At this time, the front leg 5 can stably bear pressure in working state. During normal use of the walker, the front wheel 7 can roll on the ground.

When the front leg 5 is to be folded up, an operator can rotate the hand wheel 10 to drive the front locking pin 11 to slidably retract inwardly. Thus, the front locking pin 11 is moved away from the front fitting groove 14, and no longer has limitation effect on the freedom of rotation of the front hinging shaft 13. The operator can rotate the front leg 5 toward the handle 4 such that the front hinging shaft 13 can be rotated in the folding frame body 9. When the front leg 5 is folded to be in position, another front fitting groove 14 on the front hinging shaft 13 is aligned with the position of the front locking pin 11, and the front locking pin 11 slides into the front fitting groove 14, thereby locking the front leg 5 in the folded state.

There may be at least one front fitting groove 14 and at least one rear fitting groove 17, which can be arranged along a circumference of the front hinging shaft 13 or the rear hinging shaft 16 based on different folding and unfolding positions, so as to adapt to different positions of the front leg 5 or the rear leg 6.

A rotary shaft 19 is disposed on the hand wheel 10. A blocking tongue 20 is convexly disposed on the rotary shaft 19 radially. A front blocking boss 21 is convexly disposed on the front locking pin 11 radially. The blocking tongue 20 is attached to a side of the front blocking boss 21 close to the front hinging shaft 13. A rear blocking boss 22 is convexly disposed on the rear locking pin 12 radially, and the blocking tongue 20 is attached to a side of the rear blocking boss 22 close to the rear hinging shaft 16.

The hand wheel 10 is used to drive the front locking pin 11 or the rear locking pin 12 to retract inwardly on the folding frame body 9. Under a normal locked state, the front locking pin 11 is inserted into the front fitting groove 14 or the rear locking pin 12 is inserted into the rear fitting groove 17. At this time, the blocking tongue 20 is located at the inner sides of the front blocking boss 21 and the rear blocking boss 22 respectively, that is, the blocking tongue 20 is clamped between the front blocking boss 21 and the rear blocking boss 22.

When it is required to rotate the hand wheel 10 to unlock the locked state, with the front locking pin 11 as an example, the hand wheel 10 is rotated away from the front hinging shaft 13, namely, the blocking tongue 20 is moved away from the front hinging shaft 13, and the blocking tongue 20 pushes the front locking pin 11 to retract slidably away from the front hinging shaft 13 until the front locking pin 11 completely retracts from the front fitting groove 14. Then, the front leg 5 is rotated. When the adjustment is made until the new front fitting groove 14 is aligned with the front locking pin 11, the hand wheel 10 is released. Under the traction of the front leg spring 15, the front locking pin 11 is inserted into the front fitting groove 14. At this time, the front blocking boss 21 also pushes the blocking tongue 20 to rotate to reset. The unlocking process of the rear locking pin 12 is similar to that of the front locking pin 11 except that the hand wheel 10 is rotated in reverse direction.

A front support wall 23 is disposed at the front of the lower part of the folding frame body 9, a rear support wall 24 is disposed at the back of the lower part of the folding frame body 9, and a support wheel 25 is disposed in the middle of the lower part of the folding frame body 9. A support hole is opened on the front support wall 23 and the rear support wall 24 respectively. The front locking pin 11 slides on the support wheel 25 to penetrate through the support hole of the front support wall 23 and then into the front fitting groove 14. One end of the front leg spring 15 is mounted on the front support wall 23 and the other end is mounted on the front locking pin 11. The rear locking pin 12 slides on the support wheel 25 to penetrate through the support hole of the rear support wall 24 and then into the rear fitting groove 17. One end of the rear leg spring 18 is mounted on the rear support wall 24 and the other end is mounted on the rear locking pin 12.

The front locking pin 11 and the rear locking pin 12 slide in the respective support holes while the support wheel 25 also supports the front locking pin 11 and the rear locking pin 12. Therefore, the support holes and the support wheel 25 jointly support the slide of the front locking pin 11 and the rear locking pin 12 such that the front locking pin 11 and the rear locking pin 12 can smoothly slide without being blocked, ensuring smooth implementation of locking and unlocking. The nearby mounting of the front leg spring 15 and the rear leg spring 18 also ensures the traction of the springs is close to the slide direction of the front locking pin 11 and the rear locking pin 12, avoiding unfavorable external lateral forces on the front locking pin 11 and the rear locking pin 12 except the slide force.

The connection mechanism 2 includes two support rods 26 and a connection rod 27 hinged on an upper part of each support rod 26. The two support rods 26 are crossed each other in middle part and hinged to each other, and the bottom ends of the two support rods are respectively hinged to the lower parts of the folding frame bodies 9 of the two walker frames 1. The connection rod 27 on each support rod 26 is hinged close to an upper part of the folding frame body 9 of the walker frame 1. A catch 28 is further disposed on each support rod 26, and a locking shaft 29 is disposed on the connection rod 27 hinged to the support rod 26. The catch 28 is movably snap-fitted to the locking shaft 29.

The connection mechanism 2 has folded and unfolded states. When the connection mechanism 2 is in the unfolded state, the connection mechanism 2 can reliably support the walker frames 1 on both sides to form the two walker frames 1 into one piece, making it have a structural rigidity and enabling the walker to provide external support force. When the connection mechanism 2 is in the unfolded state, with one support rod 26 as example for analysis, the bottom end of the support rod 26 is hinged to one walker frame 1 and the top end of the support rod 26 is hinged with the connection rod 27 hinged to another walker frame 1; the catch 28 fixes the relative position of the support rod 26 and the connection rod 27, that is, the connection rod 27 and the support rod 26 are combined to fix the distance between the two walker frames 1, forming a locked state; the positions of and the relative angle of the connection rod 27 and the support rod 26 cannot be changed any more, and another group of connection rod 27 and support rod 26 also fixes the distance between the two walker frames 1. Therefore, in the unfolded state, the connection mechanism 2 forms a reliably support between the two walker frames 1.

When the two walker frames 1 are to be folded, the catches 28 are first released from the corresponding locking shafts 29 and thus the relative position of the support rods 26 and the connection rods 27 can be changed. Thus, the connection rods 27 can be rotated relative to the corresponding support rods 26. When a user pushes the two walker frames 1 close to each other, the support rods 26 and the connection rods 27 will be rotated upwardly, namely, toward the handle 4, and the support rods 26 and the connection rods 27 are changed from the unfolded state to the folded state until the two walker frames 1 are attached to each other, and at this time the connection mechanism 2 can also be skillfully received between the two walker frames 1, making the entire structure of the walker compact and making it occupy smaller space. For the walker with adult model using the folding structure, the body of the walker frames 1 is made of high-performance lightweight aluminum alloy such as aluminum magnesium alloy, reducing the weight of the existing products on the markets from 7 kilograms to 5.8 kilograms, and greatly improving its portability.

What is claimed is:

1. A foldable walker, comprising two walker frames arranged in parallel and a connection mechanism connected with the two walker frames, wherein
each of the two walker frames comprises a folding assembly, a handle disposed above the folding assembly, a front leg disposed at a front of a lower part of the folding assembly and a rear leg disposed at a back of the lower part of the folding assembly, and the front leg and the rear leg are turned over and folded toward the handle around the folding assembly;
the front leg is provided with a front wheel and the rear leg is provided with a rear wheel.

2. The foldable walker according to claim 1, wherein the folding assembly comprises a folding frame body, a hand wheel mounted in a middle of the folding frame body, and a front locking pin and a rear locking pin slidably mounted in the folding frame body;
the front leg has a front hinging shaft rotatably mounted at a front of a lower part of the folding frame body; at least one front fitting groove is disposed on the front hinging shaft and the front locking pin is slidably inserted into the at least one front fitting groove; a front leg spring pulling the front locking pin toward the front hinging shaft is disposed on the folding frame body;
the rear leg has a rear hinging shaft rotatably mounted at a back of the lower part of the folding frame body; the rear hinging shaft is provided with at least one rear fitting groove, and the rear locking pin is slidably inserted into the at least one rear fitting groove; a rear leg spring pulling the rear locking pin toward to the rear hinging shaft is disposed on the folding frame body;
the hand wheel is rotated to adjust insertion depths of the front locking pin into the at least one front fitting groove and the rear locking pin into the at least one rear fitting groove.

3. The foldable walker according to claim 2, wherein a rotary shaft is disposed on the hand wheel, and a blocking tongue is convexly disposed on the rotary shaft radially; a front blocking boss is convexly disposed on the front locking pin radially, and the blocking tongue is attached to a side of the front blocking boss adjacent to the front hinging shaft; a rear blocking boss is convexly disposed on the rear locking pin radially, and the blocking tongue is attached to a side of the rear blocking boss adjacent to the rear hinging shaft.

4. The foldable walker according to claim 3, wherein a front support wall is disposed at the front of the lower part of the folding frame body, a rear support wall is disposed at the back of the lower part of the folding frame body, and a support wheel is disposed in a middle of the lower part of the folding frame body; a support hole is opened on the front support wall and the rear support wall respectively;
the front locking pin slides on the support wheel to penetrate through the support hole of the front support wall and into the at least one front fitting groove; a first end of the front leg spring is mounted on the front support wall and a second end of the front leg spring is mounted on the front locking pin;
the rear locking pin slides on the support wheel to penetrate through the support hole of the rear support wall and into the at least one rear fitting groove; a first end of the rear leg spring is mounted on the rear support wall and a second end is mounted on the rear locking pin.

5. The foldable walker according to claim 4, wherein the connection mechanism comprises two support rods and a connection rod hinged on an upper part of each of the two support rods; the two support rods are crossed each other in middle part and hinged to each other, and bottom ends of the two support rods are respectively hinged to the lower parts of the folding frame bodies of the two walker frames; the connection rod on each of the two support rods is hinged adjacent to an upper part of the folding frame body of the walker frame; a catch is further disposed on each of the two support rods, and a locking shaft is disposed on the connection rod hinged to the support rod; the catch is movably snap-fitted to the locking shaft.
